(19) United States
(12) Patent Application Publication
(10) Pub. No.: US 2002/0056994 A1
(43) Pub. Date: May 16, 2002

(54) Open air filter cooling system for gas turbine inlet cooling

(76) Inventor: John T. Irish, Indianapolis, IN (US)

Correspondence Address: C John Brannon Esq, Woodard Emhardt Naughton Moriarty & McNett, Bank One Center/Tower, 111 Monument Circle - Suite 3700, Indianapolis, IN, 46204-5137, US

(21) Appl. No.: 09/573,911

(22) Filed: May 18, 2000

(51) Int. Cl. B60L 1/02

(52) U.S. Cl. 290/2

(57) ABSTRACT

A method and apparatus for filtering and cooling air used by a gas turbine. Heat conducting liquid is pumped from a reservoir pool, routed through a heat exchanger, and pumped through a plurality of spray nozzles and allowed to fall as a shower back into the pool. At least some of the heat is extracted from the liquid as it passes through the heat transducer. The energy to run the pump is provided by the transduction of waste heat from the heat conducting liquid and/or from the hot gasses passing through the gas turbine exhaust. The air intake for the turbine is routed through the shower, where foreign particles and contaminants are removed physically and/or chemically removed therefrom.

### CROSS-REFERENCE TO RELATED APPLICATIONS

This application claims priority to U.S. Provisional Application Serial No. 60/135,064 filed May 20, 1999.

### TECHNICAL FIELD OF THE INVENTION

The present invention generally relates to heat recovery devices and, more particularly, to a turbine inlet air cooler system.

### BACKGROUND OF THE INVENTION

Although electric power is utilized in diverse ways in the economy and demand remains high at all times, the demand for electric power nevertheless fluctuates markedly during the course of a day. Business demand is high throughout daylight hours in the operation of stores and offices, but diminishes significantly thereafter. Residential demand is highest in the evening hours. Industrial demand is relatively steady and high at all times. Other demands, such as for urban transportation, peak at differing times. Additionally, demand can vary greatly seasonally and with short-term changes in the weather. For example, electricity usage soars on abnormally hot days due to widespread use of air conditioning equipment.

In an optimized power utilization system, all such demands would be complementary and thus provide a substantially constant power requirement which could be served readily by the various sources of electric power in a readily predictable manner. In reality, however, electric power demand is nowhere near constant.

The uneven demand for electric power requires that power generation capacity be sufficiently great to accommodate the maximum instantaneous demand. This, in turn, leads to uneconomic operation of generally over-sized electric power generation facilities. One approach to this problem has been the encouragement of off-peak usage of electric power in an effort to restructure the demand pattern. Another approach has been the installation of additional generating facilities intended for use during the periods of peak power demand. For example, an electric utility may lease one or more gas turbine electric generators in order to bring on-line more power generation capacity during warmer months of the year.

One such prior art gas turbine electric generator is illustrated in FIG. 1 and indicated generally at 10. The turbine 10 is housed within a structure 12 having an air inlet 14 and an exhaust stack 16. The gases exiting the top of the exhaust stack 16 are extremely hot, typically in the neighborhood of 900° F.

This exhausted heat is energy that is not being utilized by the system, thus drastically lowering the efficiency of the turbine 10. This heat represents energy that is consumed by the turbine 10 but not turned into useful generated electricity.

Furthermore, the turbine 10 generally does not operate at peak efficiency due to the relatively high temperature of the ambient air entering the inlet 14. This is because the air becomes less dense as its temperature increases, lowering the amount of energy per unit volume contained therein.

Obviously, it would be desirable to recover the energy being lost as heat from the turbine 10 (or any other system that produces wasted heat exhaust) and convert this heat to a useful form. It would also be desirable to lower the temperature of the air entering the inlet 14 in order to improve the efficiency of the turbine 10. The present invention is directed toward these goals.

### SUMMARY OF THE INVENTION

The present invention an air filtration and cooling system for treating air used by a gas turbine. One form of the present invention includes a reservoir pool of heat conducting liquid, from which heat conducting liquid is pumped through a plurality of spray nozzles and allowed to fall as a shower back into the pool. The energy to run the pump is provided by the transduction of waste heat from the turbine exhaust. The air intake for the turbine is routed through the shower, where foreign particles and contaminants are removed therefrom.

Another form of the present invention includes a reservoir pool of heat conducting liquid, from which heat conducting liquid is pumped through a heat exchanger for cooling and then sprayed through a plurality of spray nozzles and allowed to fall as a shower back into the pool. The energy to run the pump is provided by the transduction of waste heat from the turbine exhaust. The air intake for the turbine is routed through the shower, where foreign particles and contaminants are removed therefrom while the air is cooled and densified.

One object of the present invention is to provide an improved system for efficiently filtering and cooling gas turbine intake air. Related objects and advantages of the present invention will be apparent from the following description.

### BRIEF DESCRIPTION OF THE DRAWINGS

FIG. 1 is a perspective view of a prior art gas turbine electric generator.

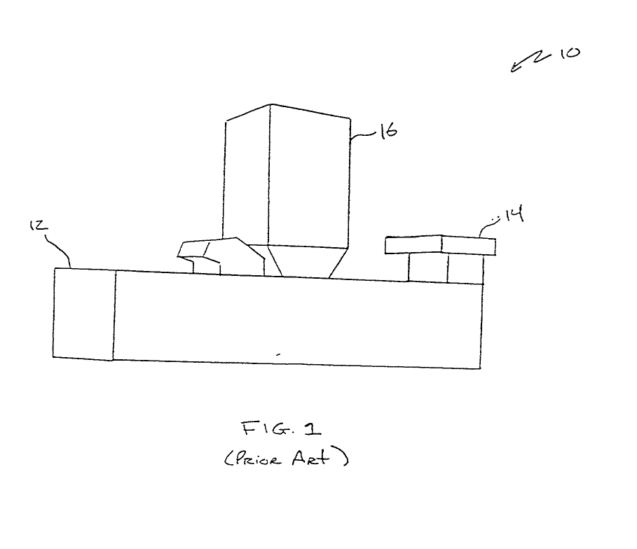

FIG. 2 is a schematic diagram of a heat recovery system of the present invention.

FIG. 3 is a plan view of a pair of heat recovery coil units of the present invention.

FIGS. 4A-B are schematic side elevational views of one of the heat recovery coil units of FIG. 3.

FIG. 5 is a side elevational semi-schematic view of a first embodiment turbine inlet air cooler system of the present invention.

FIG. 6 is a top plan semi-schematic view of a second embodiment turbine inlet air cooler system of the present invention.

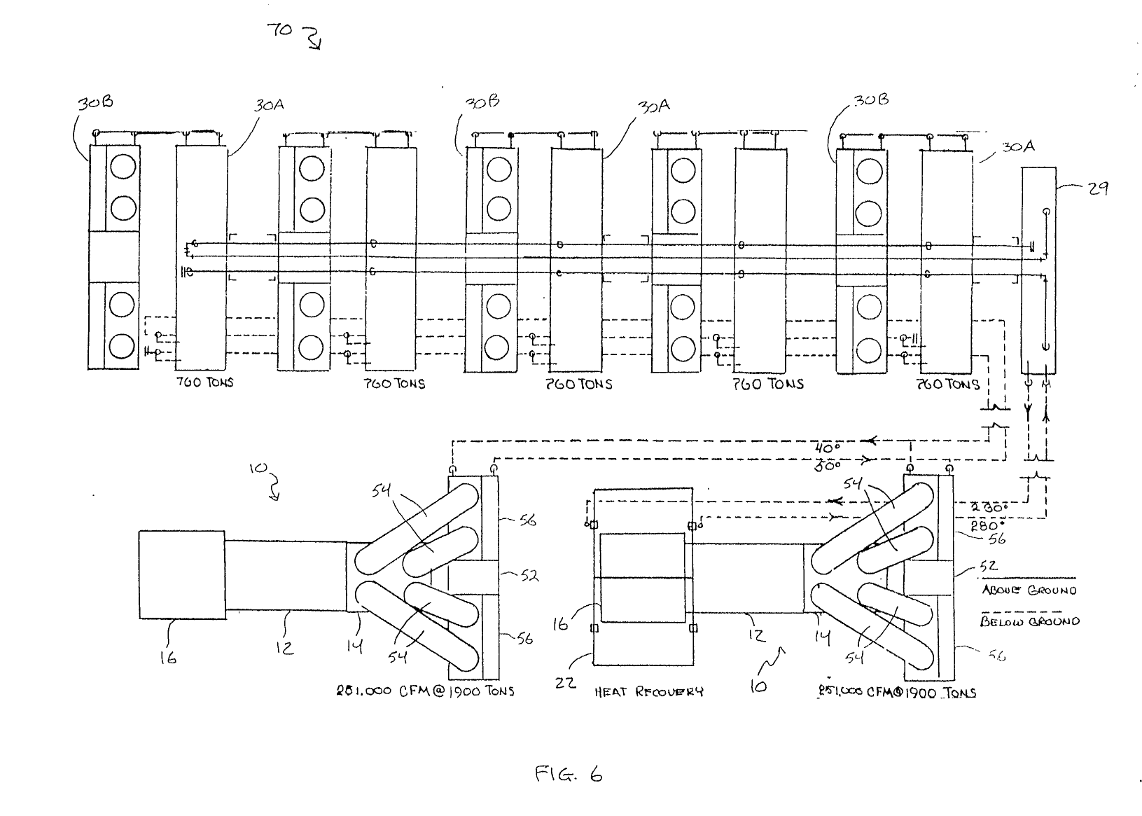

FIG. 7 is a top plan semi-schematic view of an evaporative cooler and turbine inlet of the present invention.

FIG. 8 is a schematic diagram of the evaporative cooler of FIG. 7, detailing its filtering system.

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

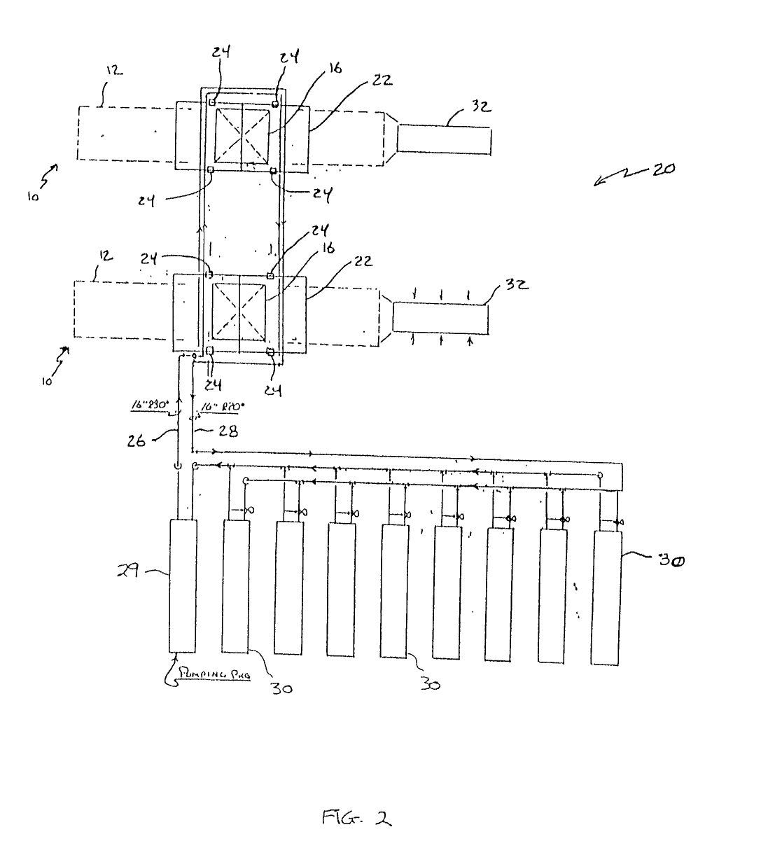

The use of a heat recovery system of the present invention with a pair of gas turbine electric generators 10 is illustrated schematically in FIG. 2, and indicated generally at 20. The heat recovery system 20 is illustrated in use with two turbines 10, however it will be understood that the present invention may be used with any number of turbines 10. In fact, the heat recovery system of the present invention may be used with any heat-producing device, and may be configured to work with any number of sources of such heat.

FIG. 2 is a schematic top plan view, such that the tops of the heat exhaust stacks 16 are visible. In order to capture the heat emitted from the exhaust stacks 16, a system of heat recovery coils 22 are positioned above the stack 16 on a superstructure supported by posts 24. This allows the heat recovery coils 22 to be supported above the exhaust stacks 16 upon their own superstructure, thereby allowing the heat recovery system 20 to be installed without modification to the turbine 10. The present invention also comprehends an embodiment in which the heat recovery coils 22 are attached to the top of the exhaust stack 16 or otherwise physically integrated with the turbine 10.

As is known in the art, the heat recovery coils work on a heat exchange principle, in which a heat conducting medium, such as water, is flowed through a series of coils in the path of the exhaust emitted by the exhaust stack 16, such that the water within the coils is heated by the exhaust. If the water within the coils is caused to continuously flow, the heat captured from the exhaust is moved away from the exhaust stack 16 to a place where it can be recovered into useful energy. The use of water in the heat recovery coils 20 is a preferred embodiment of the present invention; however, any material may be used. For example, it is known in the art to use various oils for heat exchange (such as DOWTHERM manufactured by The Dow Corporation), in order to increase the temperature at which the heat recovery coils 22 may operate. It is also known in the art to pressurize the heat recovery medium, in order to allow it to absorb more heat. For example, water may be pressurized so that it may be heated to significantly higher temperatures before turning to steam than would be the case if the water were at normal atmospheric pressure. The present invention comprehends the use of any material for the heat exchange medium.

In the preferred embodiment, the heat exchange water is pumped to the heat recovery coils 22 by means of a 16″ pipe 26 and is recovered from the heat recovery coils 22 by means of a 16″ return pipe 28. In a preferred embodiment, the water entering the heat recovery coils 22 is at approximately 230° F., while the water exiting the heat recovery coils 22 is at approximately 270° F. This 40° F. increase in the temperature of the water represents energy that has been recovered from the exhaust of the stacks 16. This heated water is pumped by a pumping package 29 into one or more chillers 30, which maintains the flow of water through the system, and uses the chillers 30 for extracting the heat energy in the water, as is commonly known in the art. The number of chiller units 30 required for the application depends upon the quantity of heat being recovered from the turbines 10. In a preferred embodiment, the pumping package 29 and chiller units 30 are contained within trailers in order to easily allow greater capacity to be added, or capacity to be taken away.

As is known in the art, the chillers 30 extract heat energy from the water flowing through the heat recovery coils 22 and produce useful energy for any desirable purpose. For example, this transduced waste heat energy may be placed onto the electric grid that is being fed by the turbine generators 10. As a further example, this transduced waste heat energy may be used to power air cooling devices 32 that are added to the air inlet 14 of each turbine 10. The cooling devices 32 cool the inlet air to the turbine 10, thereby increasing the efficiency of the turbine 10. Use of the recovered energy for inlet air cooling is discussed in greater detail hereinbelow.

One concern with the use of the heat recovery coils 22 in the path of exhaust gases as hot as those exiting the stack 16, is that if the fluid within the coils 22 is allowed to heat to too high a temperature, an explosion is possible. For example, if water is flowing through the heat recovery coils 22, and the temperature of the water is elevated above the boiling point of the water (at the pressure at which it is maintained), then the water will turn to steam, greatly expanding its volume and causing an explosion. Such a scenario may occur if the pumping package 29 fails and the water within the heat recovery coils 22 is not flowed at a high enough rate.

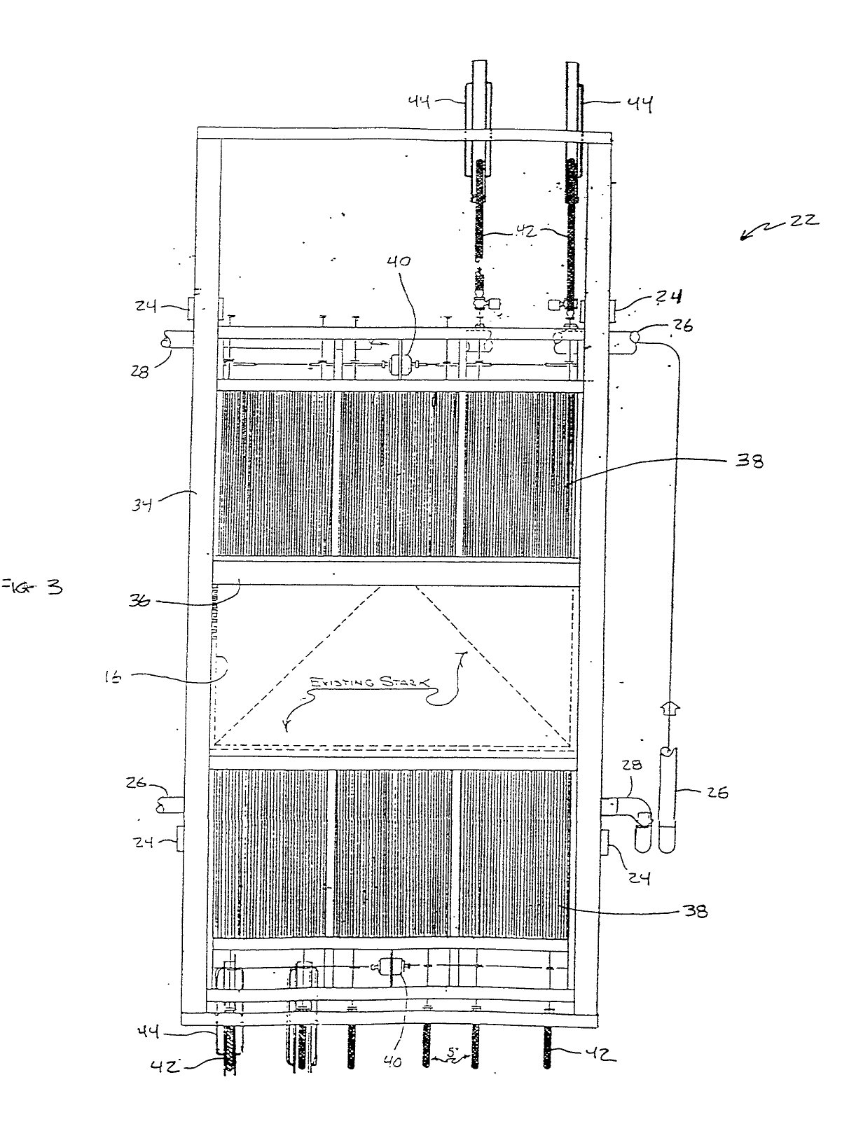

In order to guard against this problem, the present invention provides for heat recovery coils 22 as configured in FIG. 3. Visible in the view of FIG. 3 is the superstructure 34 which rests upon the posts 24 and which holds the components of the heat recovery coils 22. The superstructure 34 includes a central crossbeam 36 which crosses substantially over the centerline of the exhaust stack 16.

The heat recovery coil 22 comprises two separate coil units 38 which are independently plumbed to the inlet water pipes 26 and the outlet water pipes 28. In turn, each of the coil units 38 comprises three individual coils in the preferred embodiment. The number of coils or coil units is not critical to the present invention, and is considered to be a matter of design choice.

Each of the coil units 38 rides upon wheels or other structures which allow it to be slid upon the side rails of the superstructure 34. In this way the coil unit 38 may be moved into or out of the path of the exhaust flow exiting the stack 16. Furthermore, the coil unit 38 may be moved partially into the exhaust flow, moved entirely into the exhaust flow, or moved completely out of the exhaust flow. Each of the two coil units 38 may be moved independently. In the view of FIG. 3, the upper coil unit 38 is shown positioned completely within the exhaust flow, while the lower coil unit 38 is shown positioned completely out of the exhaust flow. It can be seen with reference to FIG. 3 that when both coil units 38 are positioned completely within the exhaust flow, all of the exhaust produced by the stack 16 is forced to flow around the coils of the coil units 38. In a preferred embodiment, the coil units 38 are moved by means of an electric motor 40 which drives a rack and pinion system attached to the superstructure 34; however, the present invention comprehends the use of any means for moving the coil units 38, the particular choice of motive means not being critical to the present invention.

Because the water inlet pipes 26 and outlet pipes 28 are fixed and because the coil units 38 are moveable, some means must be provided for connecting these structures for water flow therebetween. In a preferred embodiment to the present invention, these connections are made by lengths of 5″ braided stainless steel flexible hose that connect both to the inlet pipes 26/outlet pipes 28 and to the individual coils of the coil unit 38. For each coil, one flexible hose 42 is provided for the inlet and a second flexible hose 42 is provided for the outlet. Therefore, for the coil units 38 illustrated in FIG. 3, three pairs of flexible hose 42 are required for each coil unit 38 (as illustrated in relation to the lower coil unit 38); only one pair of the hoses 42 is illustrated in relation to the upper coil unit 38. As an alternative, each of the coils within the coil unit 38 may be chained together in a series, so that only one inlet hose 42 and one outlet hose 42 is required to service the entire coil unit 38.

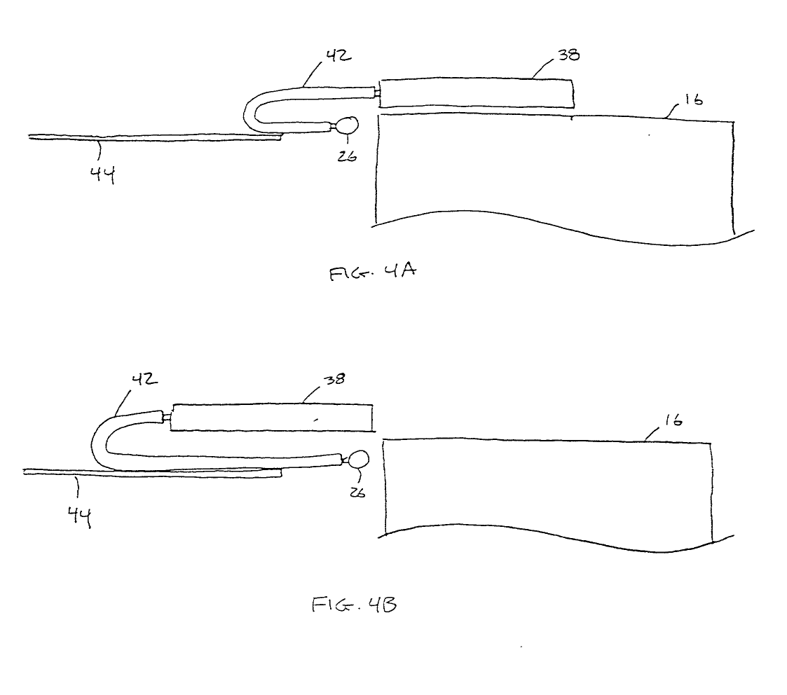

The hoses 42 are provided in a length sufficient to reach between the pipes 26, 28 and the coil unit 38 when the coil unit 38 is moved to a position representing its maximum distance from the pipes 26, 28. In the embodiment FIG. 3, this position is the position illustrated by the lower coil unit 38. Conversely, when the coil unit 38 is moved to be completely within the exhaust path of the stack 16, the hose 42 connections to the coil unit 38 will be very near the hose 42 connections to the pipes 26, 28. Therefore, the hoses 42 will assume a generally U-shaped configuration therebetween. The hoses 42 are supported by a series of trays 44 no matter what position the hoses 44 are placed in. This is illustrated schematically in FIGS. 4A-B. In the view of FIG. 4A, the coil unit 38 is positioned entirely over the stack 16, and the hose 42 assumes its shortest overall dimension. In the view of FIG. 4B, the coil unit 38 has been moved completely away from the stack 16, extending the hose 42 to its longest dimension. In either position, the tray 44 supports a portion of the hose 42, and the U-shaped configuration of the hose 42 allows it to transition between these two extreme positions without kinking.

With the configuration of the heat recovery coil 22 illustrated in FIG. 3, it is possible to actively control the position of the coil units 38 in relation to the temperature of the coil units 38. A control system (not shown) may be integrated with the heat recovery coil 22 in order to measure the temperature of the coil units 38 by means of an appropriate sensor. Such sensor may measure the temperature of the coils themselves, or may measure the temperature of the heat exchange fluid flowing through the coils. Based upon this temperature, the control system may determine whether the coil units 38 should be moved farther into the stack 16 exhaust or farther away therefrom. The control system may activate the motor 40 in order to achieve such movement. Such control of the position of the heat recovery coil units 38 would not only prevent catastrophic failure of the system in the case of extremely elevated temperatures, but would also allow the temperature of the coil units 38 to be maintained at the optimum temperature for heat recovery. The position of the coil units 38 could therefore be continuously controlled by the control system in order to achieve this optimum temperature. The implementation of such a control system may utilize any appropriate hardware known in the art, and preferably utilizes a PLC control system commercially available from the Allen-Bradley Company.

As a fail-safe safety measure, the heat recovery coil 22 is preferably designed such that failure of the control system will result in the coil units 38 automatically moving out of the exhaust path of the stack 16. It is therefore necessary for the control system to actively command the coil units 38 to be in the path of the exhaust of the stack 16 at all times. Failure of the control system 40 to send such control signals (for example, if there is a loss of power to the control system) will result in the coil units 38 automatically retracting away from the exhaust stack 16. If such a fail-safe were not provided, failure of the control system would result in the coil units 38 remaining in the path of the exhaust indefinitely, and could result in a dangerous elevation of temperature.

Several methods for implementing such fail-safe measures may be used. For example, a cable may be attached to the side of the coil unit 38 which is opposite to the stack 16. This cable may be routed through a pulley suspended from the superstructure 34 and a large weight attached to the other end of the cable. Upon a loss of a command signal from the control system activating the motor 40, there would be nothing counteracting the gravitational pull on the weight, and the weight would act to pull the coil unit 38 away from the stack 16. In an alternative embodiment, the rails of the superstructure 34 upon which the coil unit 38 rolls may be slightly angled away from the stack 16. Therefore, upon loss of a control system signal activating the motor 40, gravitational action upon the coil unit 38 will cause it to roll down this inclined ramp and away from the stack 16. Other methods for automatically moving the coil units 38 away from the stack 16 upon a loss of control signal to the motor 40 will be apparent to those having ordinary skill in the art, and are comprehended by the present invention.

As discussed hereinabove, the energy recovered by the heat recovery coils 38 may be used to power a system for cooling the air presented to the air inlet 14 of the turbine 10. Cooling this inlet air increases the density of the air and therefore its energy per unit volume, thereby increasing the efficiency of the turbine 10. With the system of the present invention, it is possible to cool the inlet air to the turbine 10 using only power recovered from the exhaust exiting the stack 16 in a substantially closed system.

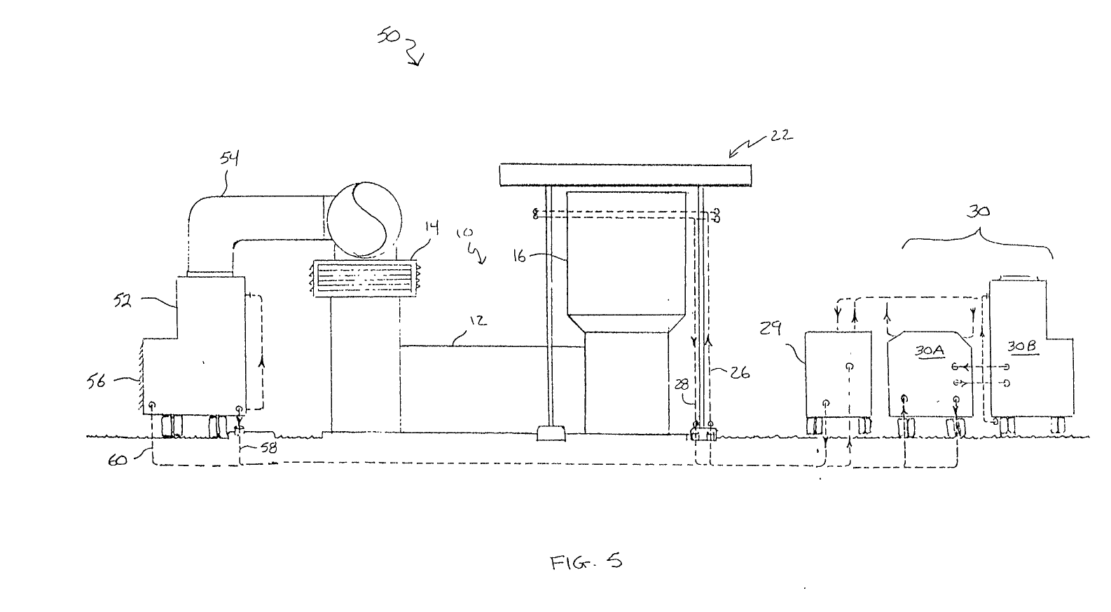

With reference to FIG. 5, there is illustrated a side elevational view of a first embodiment turbine inlet air cooler system of the present invention, indicated generally at 50. The system 50 is similar to the system 20 of FIG. 2, in that heated heat recovery fluid from the heat recovery coils 22 is pumped through the pipe 28 by the pumping package 29 to the chillers 30 (here comprising a chiller unit 30A and an associated evaporative cooler 30B). The heat of this fluid is used to power the chillers 30 and in the process the temperature of the fluid is lowered approximately 50°. This lower temperature fluid is then returned to the heat recovery coils 22 through the pipe 26. In the system 50, however, the chillers 30 are not used solely for reducing the temperature of the heat recovery medium used in the heat recovery coils 22. The chillers 30 are also used in conjunction with an evaporative cooler 52 which is used to cool the air entering the turbine inlet 14, thereby increasing the efficiency of the turbine 10.

In a preferred embodiment of the present invention, the cooler 52 is an evaporative cooler available from Baltimore Aircoil (BAC). As is known in the art, an evaporative cooler operates by pumping water (or other fluid) to the top of the cooler 52 and spraying it downward. The air entering the cooler 52 is passed through this spray of water and is substantially cooled in the process. The cool, dense air leaving the evaporative cooler 52 is fed to the turbine air inlet 14 by means of one or more conduits 54. The turbine 10 provides the suction which causes the air to move through the evaporative cooler 52. Air enters the evaporative cooler 52 at the air inlet 56.

In the process of cooling the air moving through the cooler 52, the water used by the cooler 52 absorbs heat. This water may be pumped to the chillers 30 through a conduit 58, cooled and then returned to the cooler 52 by means of the conduit 60 to be used in cooling inlet air. In a preferred embodiment of the present invention, the chilled water entering the cooler 52 is maintained at approximately 40° F. After being used to coil the inlet air, the water is elevated to a temperature of approximately 50° F. and is then pumped to the chillers 30.

A top plan view of a second embodiment turbine inlet air cooler system of the present invention is illustrated, and indicated generally at 70. The system 70 is similar to the system 50, with the exception that inlet air coolers 52 are provided for two separate turbines 10. The energy recovered by heat recovery coils 22 which are placed over the stack 16 of only one of the two turbines 10, is sufficient to power the chillers 30 which provide chilled water for both inlet air evaporative coolers 52.

The use of the evaporative cooler 52 to cool the inlet air to the turbine 10 represents a significant advancement over prior art turbine inlet air coolers which utilized heat exchanging coils. A typical turbine 10 will be located outdoors, often in a rural area, and will be ingesting on the order of 250,000 cubic feet per minute of inlet air. In order to prevent airborne debris, that are sucked in along with the inlet air, from fouling the turbine 10 as well as the prior art heat exchange coil, large and expensive media filters must be placed on the inlet side of the coolers. Not only are such filters expensive, but they represent a continuous and expensive maintenance cost in cleaning and/or replacing the filter material.

The evaporative cooler 52 of the present invention passes the inlet air stream through a shower of falling water, which acts as a scrubber to remove even very fine particulate matter from the inlet air stream. The droplets of falling water interact with the incoming airborne particulate matter and force this matter out of the air stream and into a collecting pool at the bottom of the cooler 52. As a result, the air exiting the cooler 52 into the conduits 54 is not only chilled, but is extremely clean.

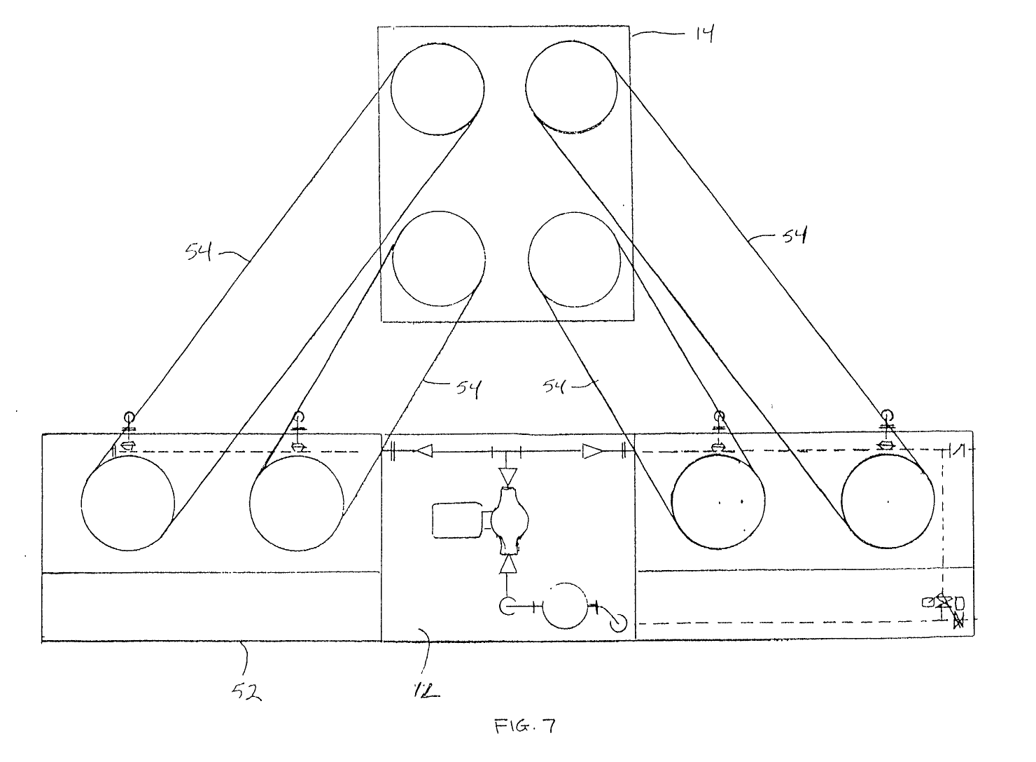

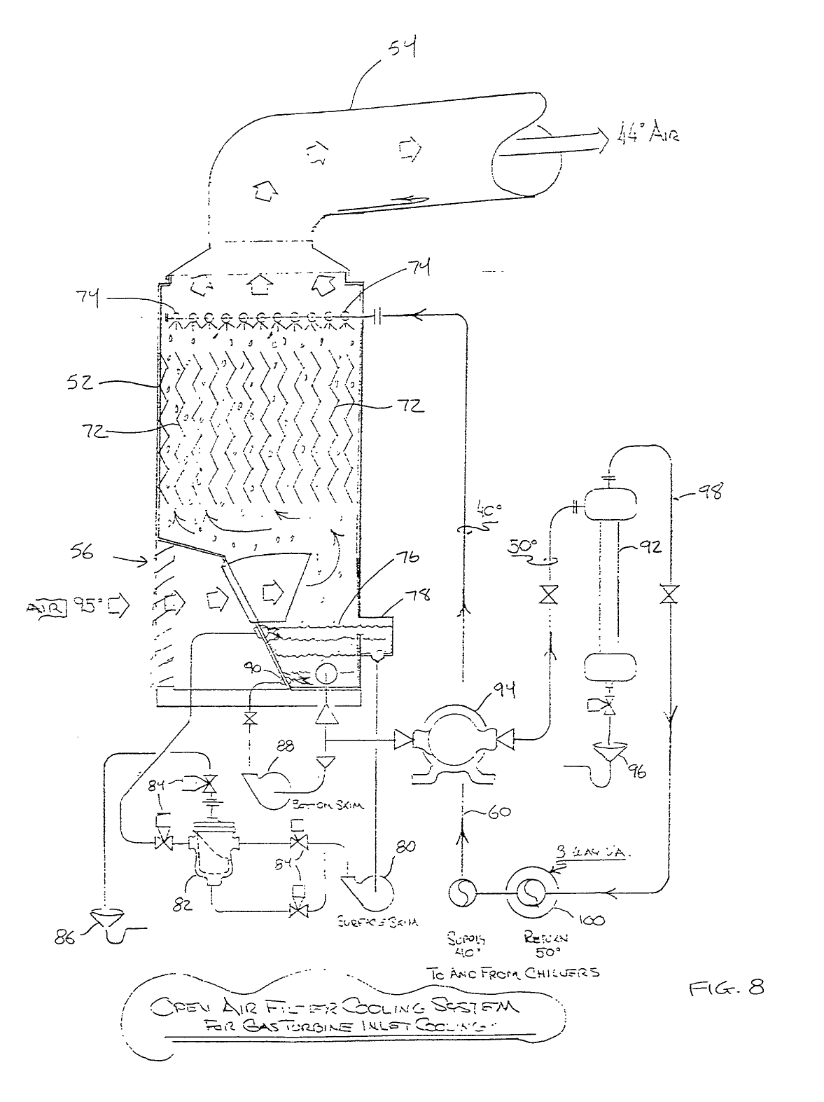

FIG. 7 illustrates a top plan view of a preferred embodiment evaporative cooler 52 of the present invention. FIG. 8 illustrates a side cross-sectional view of the evaporative cooler 52. The cooler 52 contains several filters which are operative to clean the water collected in the bottom of the cooler, thereby removing any particulate matter which has been filtered from the incoming air stream. As shown in FIG. 8, the cooler 52 allows inlet air to enter the cooler through the air inlet 56. This air is transferred to the conduit 54 by means of suction generated by the turbine 10. Internal to the cooler 52 is a media structure or manifold 72, which is preferably formed from polyvinyl chloride (PVC) formed into a shape to cause turbulent flow of the air therethrough. Cooling water is sprayed into the top of the media structure 72 by means of a plurality of nozzles 74. This water falls through the media structure 72 by the force of gravity. Interaction within the media structure 72 between the falling water and the rising air causes the water droplets to interact with the incoming airborne particulate matter and to cause this matter to be deposited in the pool 76 formed in the bottom of the cooler 52.

Large scale debris, such as leaves, insects, seed hulls, etc., will float on the surface of the water collected in the pool 76 and may be removed by means of a top surface skimming device 78. Water and debris within the top surface skimmer 78 is routed through a pump 80 to a basket strainer 82, which removes the large scale particulate matter and returns the filtered water to the top of the pool 76. By control of the valves 84, the water coming from the pump 80 may be used to blow out the trapped debris in the basket strainer 82 to the drain 86.

Non-floating particulate matter will sink to the bottom of the pool 76, where a bottom skimming system acts to keep the particulate matter suspended in the water and off of the bottom of the cooler 52. This bottom skimming system removes water from the pool 76 by means of a pump 88 and routes this water to a series of water jets 90 aimed at the bottom surface of the cooler 52. High velocity water exiting these water jets 90 acts to blast the particulate matter off of the bottom of the cooler 52 and suspend the matter into the water in the pool 76.

The main filtering of the water in the pool 76 is performed by a centrifugal filter 92 which is fed by a pump 94. The centrifugal filter 92, which is preferably of the type manufactured by LAKOS, is able to remove particulate matter from the water down to the 75 micron size. This particulate matter is deposited into a drain 96. The clean water exits the centrifugal filter 92 into the conduit 98 which is controlled by a three-way valve 100. In one position, the three-way valve 100 returns this filtered water to the chillers 30 in order to lower the temperature thereof prior to returning the chilled water to the cooler 52 supply line 60. Alternatively, the three-way valve may be positioned so that the filtered water exiting the centrifugal filter 92 is routed directly to the evaporative cooler 52 supply line 60 without being returned to the chillers 30. In this mode, the cooler 52 may be used strictly as a filter for the inlet air without cooling the air. This may be desirable in situations where the ambient air surrounding the turbine 10 is of a low enough temperature that cooling of this inlet air is not desirable.

In one alternate embodiment, the pool 76 may be filled with another heat conducting liquid, such as ammonia. In this embodiment, ammonia is circulated through the turbine inlet air cooler system 50 as indicated above to produce an ammonia shower capable of cooling and cleaning the turbine inlet air. It should be noted that by varying the composition of the heat conducting liquid, chemical as well as physical air scrubbing and purifying effects may be enjoyed.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A air filtration and cooling system for gas turbine inlets powered by recaptured waste heat from exhaust stacks, comprising:
an exhaust stack adapted to constrain flowing hot gasses and defining a hot zone;
a set of heat recovery coils adapted to be at least partially introduced into the hot zone;
a chiller hydraulically connected to the set of heat recovery coils;
a heat conducting liquid at least partially filling the coils; and
an evaporative cooler hydraulically and electrically connected to the chiller and further comprising:
an air inlet;
a media structure for directing air flow positioned in pneumatic communication with the air inlet;
a cooler inlet conduit for receiving chilled liquid extending in hydraulic communication between the evaporative cooler and the chiller;
a pump in hydraulic communication with the cooler inlet conduit and in electrical communication with the chiller;
a plurality of spray nozzles in hydraulic communication with the cooler inlet conduit and adapted to produce a shower of chilled heat conducting liquid;
a pool;
a shower of chilled heat conducting liquid falling between the plurality of spray nozzles and the pool; and
a pool outlet conduit extending in hydraulic communication between the pool and the chiller;
wherein the hot gasses flowing through the hot zone heat the heat conducting liquid at least partially filling the coils placed in thermal communication therewith;
wherein the heat conducting liquid at least partially filling the coils is pressurized to flow through the chillers; and
wherein the chiller extracts heat from the heat conducting liquid flowing therethrough for transduction into electrical energy;
wherein the electrical energy produced by the chiller is used to power the pump;
wherein the media structure actuates turbulent air flow therethrough;
wherein the media structure directs turbulent air flow through the shower of chilled heat conducting liquid; and
wherein the shower of chilled heat conducting liquid cools and filters air passing therethrough.

2. The air filtration and cooling system of claim 1 further comprising a turbine positioned in pneumatic communication with the evaporative cooler, wherein actuation of the turbine draws air through the evaporative cooler.

3. The air filtration and cooling system of claim 1 wherein the pool further includes a top skimmer and a bottom skimmer connected thereto and a main filter hydraulically connected between the pool and the outlet conduit.

4. The air filtration and cooling system of claim 3 wherein the main filter is a centrifugal filter.

5. The air filtration and cooling system of claim 1 further comprising;
a three-way valve connected in hydraulic communication with the pool, the pool outlet conduit, and the plurality of spray nozzles and having a first position and a second position;
wherein placing the three-way valve in the first position directs a shower of chilled liquid through the plurality of spray nozzles to cool and scrub air passing therethrough; and
wherein placing the three-way valve in the second position directs unchilled water through the plurality of spray nozzles to scrub air passing therethrough.

6. The air filtration and cooling system of claim 1 wherein the heat conducting liquid is ammonia.

7. The air filtration and cooling system of claim 1 wherein the heat conducting liquid is water.

8. The heat recovery system of claim 1 further comprising:
a turbine positioned in pneumatic communication with the evaporative cooler; and
a three-way valve connected in hydraulic communication with the pool, the pool outlet conduit, and the plurality of spray nozzles and having a first position and a second position;
wherein actuation of the turbine draws air through the evaporative cooler;
wherein the pool further includes a top skimmer and a bottom skimmer connected thereto and a main filter hydraulically connected between the pool and the outlet conduit;
wherein the main filter is a centrifugal filter;
wherein placing the three-way valve in the first position directs a shower of chilled liquid through the plurality of spray nozzles to cool and scrub air passing therethrough; and
wherein placing the three-way valve in the second position directs unchilled water through the plurality of spray nozzles to scrub air passing therethrough.

9. A system for scrubbing gas turbine inlet gasses, comprising:
an exhaust gas hot zone;
at least one heat recovery coil positioned at least partially within the hot zone;
a heat transducer in thermal communication with the at least one heat recovery coil;
a turbine air inlet;
a manifold for directing air flow positioned in pneumatic communication with the air inlet;
a pool of heat conducting liquid;
a pump connected in hydraulic communication with the pool of heat conducting liquid and connected in electrical communication with the heat transducer;
a transducer inlet conduit for receiving heat conducting liquid extending in hydraulic communication between the pool of heat conducting liquid and the heat transducer;
a transducer outlet conduit hydraulically connected to the heat transducer;
a plurality of spray nozzles connected in hydraulic communication with the transducer outlet conduit and adapted to spray a shower of heat conducting liquid into the pool;
a shower of heat conducting liquid extending between the plurality of spray nozzles and the pool;
wherein the manifold directs turbulent air through the shower of heat conducting liquid.

10. The system of claim 9 wherein the heat conducting liquid is ammonia.

11. The system of claim 9 wherein the shower of heat conducting liquid filters the air flowing therethrough.

12. The system of claim 9 wherein the heat transducer is selectively actuatable.

13. The system of claim 12 wherein the shower of heat conducting liquid is chilled.

14. The system of claim 13 wherein the shower of heat conducting liquid cools and densifies the air flowing therethrough.

15. A method for filtering and densifying air flowing into a gas turbine air intake, comprising the steps of:
a) providing at least one heat recovery coil at least partially filled with a heat conducting fluid and positioned at least partially within a hot zone of an exhaust stack;
b) extracting heat from the hot zone;
c) providing a heat transduction system in fluid communication with the at least one heat recovery coil;
d) transducing at least some of the heat extracted from the heat recovery coil to produce electricity;
e) providing a recirculating liquid shower system in electric and hydraulic communication with the heat transduction system;
f) powering the recirculating liquid shower system with the electricity produced by heat transduction; and
g) providing a gas turbine having an air inlet pathway directed through the liquid shower system.

16. The method of claim 15 further including the step of:
h) filtering the air flowing through the recirculating liquid shower system.

17. The method of claim 15 further including the step of:
i) cooling the air flowing through the recirculating liquid shower system.

18. The method of claim 15 further including the steps of:
j) routing heated water from the recirculating liquid shower system through the heat transduction system;
k) extracting at least some of the heat from the heated liquid; and
l) transducing at least some of the extracted heat into electricity.

19. An apparatus for cleaning air for intake be a gas turbine, comprising:
means for recovering and transducing at least some industrial waste heat into electricity;
heat conducting liquid flowable through the means for recovering and transducing at least some industrial waste heat into electricity
a turbine air inlet;
a manifold for directing air flow positioned to receive air from the air inlet;
a hydraulic pump electrically connected to the means for recovering and transducing at least some industrial waste heat into electricity;
an inlet conduit for receiving chilled liquid extending in hydraulic communication between the means for recovering and transducing at least some industrial waste heat into electricity and the pump;
a plurality of spray nozzles in hydraulically connected to the inlet conduit;
a pool;
a shower of heat conducting liquid falling between the plurality of spray nozzles and the pool; and
an outlet conduit extending in hydraulic communication between the pool and the means for recovering and transducing at least some industrial waste heat into electricity;
wherein the means for recovering and transducing at least some industrial waste heat into electricity extracts heat from the heat conducting liquid flowing therethrough for transduction into electrical energy; and
wherein the shower of chilled heat conducting liquid cools and filters air passing therethrough.

20. The apparatus of claim 19 wherein the electrical energy produced by the means for recovering and transducing at least some industrial waste heat into electricity is used to power the pump.

21. The apparatus of claim 19 wherein the manifold actuates turbulent air flow therethrough and wherein the manifold directs turbulent air flow through the shower of chilled heat conducting liquid.

22. The apparatus of claim 19 wherein the heat conducting liquid is water.
